(19) United States
(12) Patent Application Publication
(10) Pub. No.: US 2013/0342618 A1
(43) Pub. Date: Dec. 26, 2013

(54) FLUID CONTAINER HAVING TWO SEALING FILMS FOR MICRO-FLUID APPLICATIONS

(71) Applicants: Tim Frasure, Stamping Ground, KY (US); Gregory Alan Long, Georgetown, KY (US)

(72) Inventors: Tim Frasure, Stamping Ground, KY (US); Gregory Alan Long, Georgetown, KY (US)

(21) Appl. No.: 13/530,179

(22) Filed: Jun. 22, 2012

(51) Int. Cl. B41J 2/175

(52) U.S. Cl. 347/86

(57) ABSTRACT

A consumable supply item for an imaging device holds an initial or refillable volume of fluid. A housing defines an interior having a backpressure device that moves to regulate pressure in the housing as fluid exits the interior during use. A frame of the housing surrounds the interior and has a ledge. A first film seals to the ledge to prevent fluid from leaking. It is flexible to collapse inward toward the interior as the backpressure device moves inward. A second film seals to the housing over the first film and is spaced by air from the first film. The second film is relatively rigid. It is formed with metal. A tortuous air path traverses under the second film. It has an air inlet vented directly to atmosphere and an air outlet vented directly to the air space between the first and second films.

### FIELD OF THE INVENTION

The present invention relates to micro-fluid applications, such as inkjet printing. It relates particularly to supply item containers for use in such applications having two sealing films each with dedicated properties. Double-layer films facilitate certain designs.

### BACKGROUND OF THE INVENTION

The art of printing with micro-fluid technology is relatively well known. A permanent or semi-permanent ejection head has access to local or remote supplies of fluid (e.g., ink). The fluid ejects from an ejection zone to a print media in a pattern of pixels corresponding to images being printed. Containers hold the fluid for delivery to the ejection head. Container features have competing requirements depending upon application.

In designs utilizing a sealing film to confine fluid within an interior, films need to be both 1) flexible and smoothly formable to avoid adversely affecting the backpressure of a fluid system as fluid is depleted from the container, such as when a lung or spring collapses during use, and 2) have a permeation rate that limits permeation of the fluid from the interior during shipping, storage and printing. Unfortunately, films that are flexible and readily formable typically have high permeation rates, whereas films with low permeation rates are often inflexible and poorly formable.

Also, industrial environments have available to them for printing a wide variety of inks. With solvent-based inks, container requirements tend to favor sealing films that limit fluid permeation because solvents are highly corrosive and there is a desire for containment of such corrosive materials. Solvents also tend to evaporate at higher rates than water-based inks thereby controlling permeation is even more difficult by comparison. With methyl ethyl ketone (MEK) inks, containers often require specialty adhesives to avoid interfering with ink properties. With aqueous-based inks, container requirements often dictate selecting films with one set of properties in lieu of other films having competing properties.

Accordingly, a need exists in the art for better fluid containers in micro-fluid applications. The need extends not only to balancing the competing requirements of container films, especially in industrial printing contexts, but doing so economically. Additional benefits and alternatives are also sought when devising solutions.

### SUMMARY OF THE INVENTION

The above-mentioned and other problems become solved with fluid containers having two sealing films for micro-fluid applications. A first film is flexible and forms well, while a second film has a low fluid permeation rate. The former defines an inner film retaining fluid in an interior of a container and flexes inward as pressure changes in the interior during printing. The latter is an outer, larger film covering the inner film and is formed with metal having low permeation to keep fluid from escaping the interior. The two films together individually isolate the functional requirements of good bladder films.

In a representative embodiment, a consumable supply item for an imaging device holds an initial or refillable volume of fluid. A housing defines an interior having a backpressure device that moves to regulate pressure in the housing as the fluid exits the interior during use. A frame of the housing surrounds the interior and has a ledge. A first film seals to the ledge to prevent fluid from leaking. It is flexible to collapse inward toward the interior as the backpressure device moves inward. A second film seals to the housing over the first film and is spaced by air from the first film. The second film is relatively rigid and formed of metal. A tortuous air path traverses under the second film. It has an air inlet vented directly to atmosphere and an air outlet vented directly to the air space between the first and second films. Further embodiments note locations of films, sizes of films, materials of films, layers of films, thicknesses, and film attachment techniques, to name a few.

These and other embodiments are set forth in the description below. Their advantages and features will be readily apparent to skilled artisans. The claims set forth particular limitations.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIGS. 1A and 1B are full and partial perspective views of a fluid container with two films for micro-fluid applications;

FIGS. 2A and 2B are diagrammatic views of the two films during use; and

FIG. 3 is a diagrammatic view of a single film typified in two-layers for use in fluid containers.

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that process, electrical, and mechanical changes, etc., may be made without departing from the scope of the invention. The following detailed description, therefore, is not to be taken in a limiting sense and the scope of the invention is defined only by the appended claims and their equivalents. In accordance with the features of the invention, methods and apparatus include fluid containers having two sealing films for micro-fluid applications.

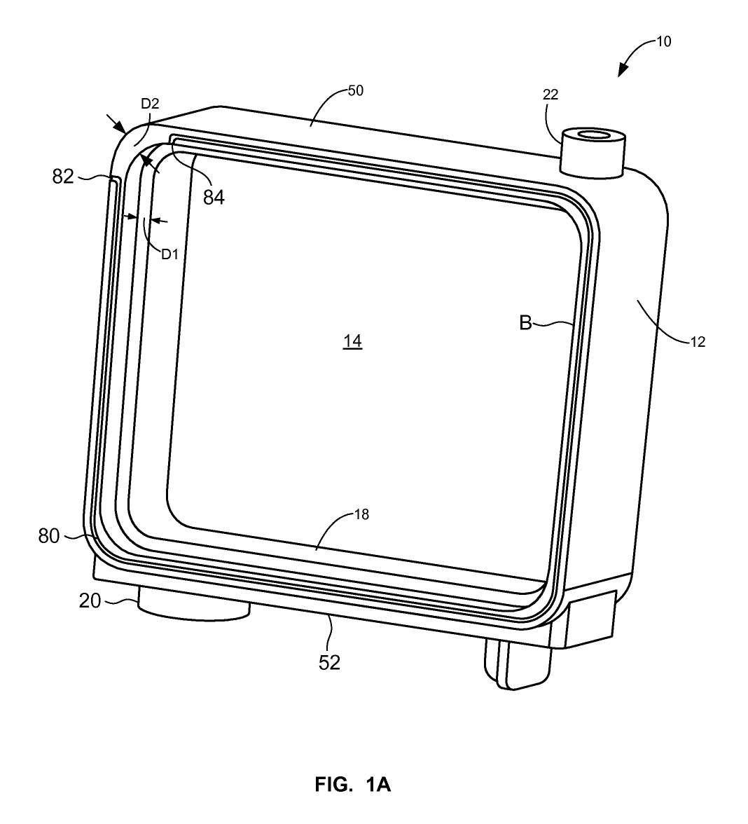

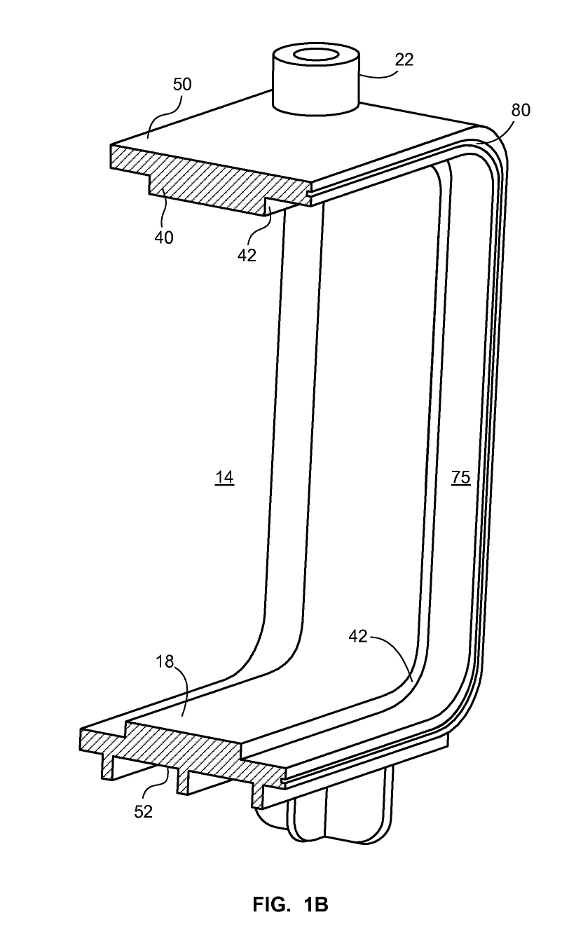

With reference to FIGS. 1A and 1B, a supply item container 10 for use in an imaging device includes a housing 12. The housing defines an interior 14 that contains an initial or refillable supply of fluid, e.g., ink. The volume of ink depletes downward toward a bottom surface 18 of the interior of the housing in a direction of gravity. The bottom surface is generally flat and ink flows out of the housing to the imaging device by way of an exit port 20. An ink fill port 22 resides on an opposite side of the housing to receive fresh ink in the interior upon initial filling or over time. The port connects to a bulk supply of fluid or to refilling devices to first fill and/or replenish ink and may be connected during use or left unconnected when used as a disposable cartridge. The ports are any of a variety but typify tubes with internal ball/spring combinations that mate with septum needles during use to draw out ink or replenish it. Seals find utility in the design to prevent leakage. Other ports can be used.

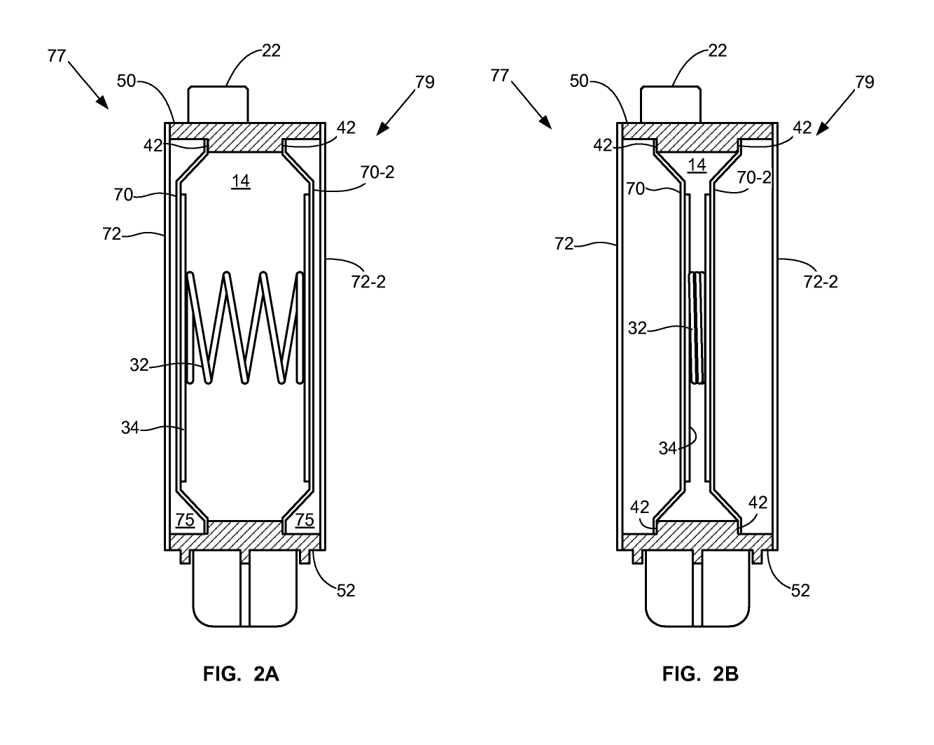

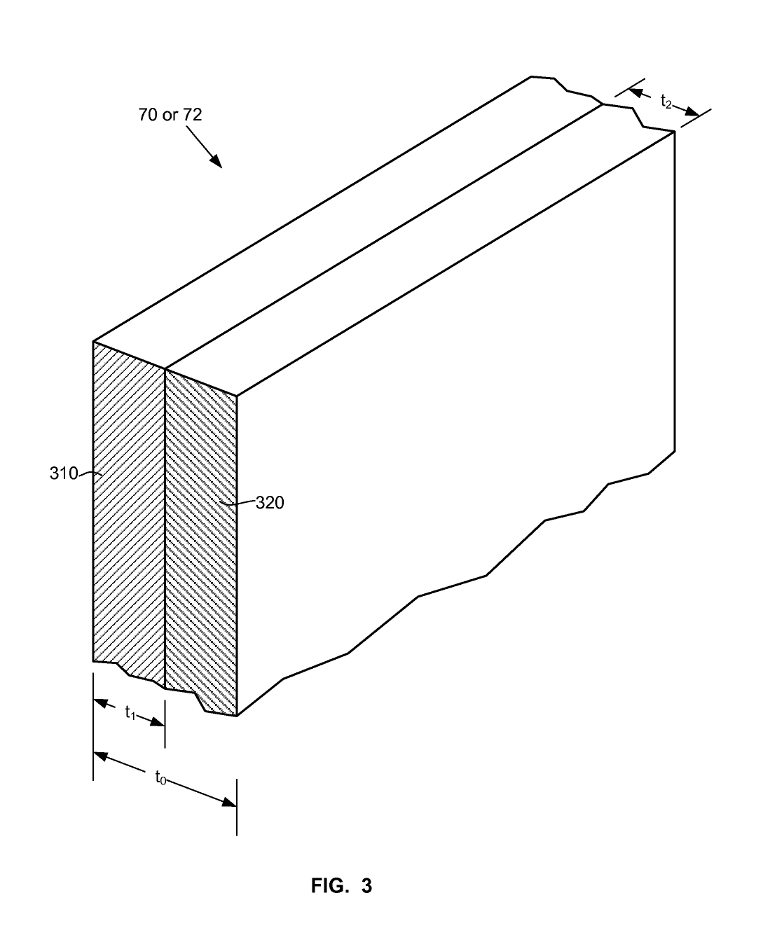

With reference to FIGS. 2A and 2B, a moveable backpressure device 30 resides in the interior 14 of the housing. It regulates pressure as fluid exits the fluid exit port during use. The device typifies a collapsible lung having a spring 32 attached to a side plate 34. As fluid depletes and fluid in the interior 14 transitions from a Full to Empty state, the spring collapses inward toward the interior and its force establishes the backpressure for the overall fluid system. As the distance traveled by the side plate 34 is relatively large, any sealing film connected to it needs great flexibility. Hence, the housing further includes a frame 40 surrounding the interior, including ledge 42 to support a first film 70 having great flexibility. The first film seals to the ledge and also to the backpressure device. It prevents fluid from leaking from the interior as the backpressure device moves inward within the interior during use. Alternatively, the first film does not attach directly to the backpressure device but still requires great flexibility as the first film follows inward the backpressure device upon collapse.

A second film 72 spaced from the first film, such as by an air gap 75, seals direct to the housing. It typifies a rigid film having low fluid permeation rates. It is preferably metalized, such as with aluminum. Alternatively, it is a laminate construction of plastic and foil. Ceramic films are also contemplated as are other designs having low permeation. It has a surface area larger than the first film so as to adequately surround the first film and cover the housing. As the first film collapses inward with great flexibility as backpressure changes in the interior, the second film remains steadfastly firm on an exterior of the housing and prevents fluid from permeating to the exterior. The two films together overcome the difficulties of the prior art by achieving both a flexible and smoothly formable first film, and rigid second film with low rates of fluid permeation.

Under the second film, a tortuous air path 80 resides. It is carved as a channel in a thickness of the housing. It traverses from an air inlet 82 vented directly to atmosphere and an air outlet 84 vented directly to the air space 75 between the first and second films. Its length and cross-sectional area are largely dependent upon application. In general, the longer the air path, the lower the evaporation rate, but a smaller cross-sectional area can also contribute to a low evaporation rate. A general rule relates a ratio of the length of the path to the cross-sectional area, whereby the higher the ratio, the lower the evaporation rate.

In further embodiments, the frame 40 has a top 50, bottom 52 and sides 77, 79 defining an endless boundary B of wall sections. The sections, formed together as one or fitted together from individual parts, define a thickness of material in which the fluid is stored in the interior 14. The interior defines a lateral opening whereby a second instance of first and second films 70-2, 72-2 attach to a second side 79 of the housing opposite the first side 77 of the housing. Also, each second instance of films attach to the frame 40 and the housing 12 as do the first instance of films 70, 72. To provide adequate structural surfaces for sealing the films to the container, it is envisioned that a distance D1 of the ledge is about 1-3 mm as there is a second distance D2 of at least this magnitude. It is envisioned that these distances are sufficiently wide to secure the films to the housing either by heat staking or ultrasonic welding. Less preferably, the films could attach by using adhesives, but such still dictates a surface of sufficient width to keep in place the films.

In composition, the housing is any of a variety of containers for holding ink. It typifies plastic, glass, metal, etc. It can be recyclable or not. Techniques for production are varied, but blow molding, injection molding, etc. are contemplated. Welding, heat-staking, bonding, dies, etc. are also envisioned. The materials, construction, shipping, storage, use, etc. of the housing can also focus designers on criteria, such as costs, ease of manufacturing, durability, or a host of other items. The shape of the housing can vary. Implicating it are good engineering practices such as contemplation of the larger imaging context in which the housing is used. In the design given, the housing is generally rectangular. Its fluid exit port 20 inserts downward into an imaging device, while its top 50 is acted upon by users for pushing. The support provided by a thickness of the housing is large enough to provide structural rigidity over a life of the container, but not so thick it consumes valuable space that could be otherwise occupied by fluid.

With reference to FIG. 3, either the first or second films 70, 72, or both, could be devised in two layers 310, 320, such as by coextrusion, adhesion, sputtering, lamination, or the like. For the flexible/formable film 70, the layer 310 facing interior to the container is representatively polyethylene. The layer 320 facing outside is representatively nylon. In thickness, the inside layer ranges from about 40 to about 45 micrometers thick (t1), whereas the outside layer is about 60 micrometers thick (t2). In other designs, the total thickness of the film ranges from about 75 to about 125 micrometers thick (t0).

When the two-layer film represents the low permeation rate film 72, the layer 310 facing the first film is representatively polypropylene. The layer 320 facing outside is a metal, such as aluminum or other pure metal, composition or alloy yielding low permeation rates. The total thickness the two-layer film ranges according to the thickness of each of the layers, but in total ranges from about 75 to about 125 micrometers thick (t0). Alternatively, the second film 72 could typify a laminate construction of a plastic layer 310 attached to a foil layer 320.

Relatively apparent advantages of the many embodiments include, but are not limited to: (1) a first film having superior flexibility and smooth formability allowing contraction of a backpressure device during use without compromising stable fluid pressure; 2) a more rigid, second film sealed outside the first film having low permeation; 3) a serpentine air path to control fluid evaporation and allow air into the volume between the first and second films; and 4) a comprehensive design affording improved consistency of fluid inside the interior of the housing as the charateristics of the films define the fluid volume, not the characteristics of the outer walls of a container.

The foregoing illustrates various aspects of the invention. It is not intended to be exhaustive. Rather, it is chosen to provide the best illustration of the principles of the invention and its practical application to enable one of ordinary skill in the art to utilize the invention, including various modifications that naturally follow. All modifications and variations are contemplated within the scope of the invention as determined by the appended claims. Relatively apparent modifications include combining one or more features of various embodiments with features of other embodiments.

1. A container to hold an initial or refillable volume of fluid, comprising:
a housing defining a fluid exit port and an interior to retain the volume of fluid, a frame of the housing surrounds the interior and has a ledge;
a moveable backpressure device in the interior to regulate the pressure in the housing as the fluid exits the fluid exit port during use;
a first film sealed to the ledge to prevent the fluid from leaking, the first film being flexible to collapse inward toward the interior as the backpressure device moves inward within the interior during use; and
a second film sealed to the housing and spaced from the first film.

2. The container of claim 1, further including air spaced between the first and second films.

3. The container of claim 1, wherein the second film is relatively inflexible.

4. The container of claim 1, wherein the second film has a water vapor transmission rate of about 0.001 to about 0.5.

5. The container of claim 1, wherein the interior defines an opening through the housing and another first film seals the interior from a side of the housing opposite a second side of the housing where the first film is sealed to the ledge.

6. The container of claim 5, wherein the another first film seals to a second ledge on the side of the housing opposite the second side of the housing.

7. The container of claim 5, wherein another second film seals against the housing on the side of the housing opposite the second side of the housing where the second film is sealed to the housing.

8. The container of claim 7, further including air spaced between the another first film and the another second film.

9. The container of claim 1, wherein the moveable backpressure device is a collapsible lung, the first film touching the collapsible lung to move with the collapsible lung.

10. The container of claim 1, wherein the first film is a two-layer film.

11. The container of claim 10, wherein an inside layer of the two-layer film facing the interior is polyethylene.

12. The container of claim 10, wherein an outside layer of the two-layer film is nylon.

13. The container of claim 11, wherein the inside layer is about 40 to about 45 micrometers thick.

14. The container of claim 12, wherein the outside layer is about 60 micrometers thick.

15. The container of claim 10, wherein the two-layer film is about 75 to about 100 micrometers thick.

16. The container of claim 1, wherein the second film is a two-layer film.

17. The container of claim 16, wherein an inside layer of the two-layer film facing the first film is polypropylene.

18. The container of claim 16, wherein an outside layer of the two-layer film is metal.

19. The container of claim 18, wherein the metal is aluminum.

20. The container of claim 16, wherein the two-layer film is about 75 to about 100 micrometers thick.

21. The container of claim 1, wherein the ledge is about 1 to about 3 mm thick to adequately seal the first film.

22. The container of claim 2, wherein the housing has a tortuous air path traversing under the second film.

23. The container of claim 22, wherein the tortuous air path has an air inlet vented directly to atmosphere and an air outlet vented directly to the air spaced between the first and second films.

24. The container of claim 1, wherein the second film has a larger surface area than the first film, the second film surrounding a surface area of the first film.

25. A container to hold an initial or refillable volume of fluid, comprising:
a housing defining a fluid exit port and an interior to retain the volume of fluid, a frame of the housing surrounds the interior and has a ledge;
a moveable backpressure device in the interior to regulate the pressure in the housing as the fluid exits the fluid exit port during use;
a first film sealed to the ledge to prevent the fluid from leaking, the first film being flexible to collapse inward toward the interior as the backpressure device moves inward within the interior during use;
a second film sealed to the housing and spaced from the first film, the second film being a metal film, wherein an air space exists between the first and second films; and
a tortuous air path in the housing traversing under the second film, the tortuous air path having an air inlet vented directly to atmosphere and an air outlet vented directly to the air space between the first and second films.
